(19) United States
(12) Patent Application Publication
(10) Pub. No.: US 2007/0269773 A1
(43) Pub. Date: Nov. 22, 2007

(54) Educational game and activity

(76) Inventor: Sandra Marie Slade, Corona, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/803,560

(22) Filed: May 14, 2007

Related U.S. Application Data
(63) Continuation-in-part of application No. 10/881,034, filed on Jun. 29, 2004.
(60) Provisional application No. 60/802,217, filed on May 19, 2006.

(51) Int. Cl. G09B 19/00; A63B 69/00

(52) U.S. Cl. 434/98; 434/247

(57) ABSTRACT

The present invention provides an educational game and activity that helps children develop fitness skills and color, number, and shape recognition abilities. The game includes a set of activity cards containing a front surface and a back surface. The front surface has an activity pictorial representation, three numbers of repetitions inside the shape of a heart, octagon or pentagon, with dots matching that amount, and an activity title located thereon. The back surface has a shape title, a shape pictorial representation, and a color title located thereon. The game also preferably includes a die used to randomly select at least one activity card from the set of activity cards. The die can contain either color designations corresponding to the color titles on the activity cards, or shape designations corresponding to shape titles and shape pictorial representations on the activity cards. The die is used to select an activity card, the activity thereon is then performed for the number of repetitions listed on the card.

This application claims the benefit of U.S. Provisional Application 60/802,217 filed May 19, 2006.

### BACKGROUND OF THE INVENTION

1. Field of the Invention

The invention relates to the field of educational games for children. More particularly, the preferred embodiment of the present invention involves an educational game containing a set of activity cards that introduces a variety of different movement and fitness skills to children, while also promoting color, number, and shape recognition.

2. Description of the Related Art

Early development of a child's mental abilities can help lead to future success in all areas of life. Many educational materials have been created to help stimulate the mental development of young children. These materials have generally focused on increasing a child's logical thinking ability, ability to associate, or communication capability. When young children are involved, particularly those with limited reading ability or those in or about to enroll in pre-school, the most effective educational materials generally consist of cards containing various pictures of persons or objects rather than pages of written material. These cards are generally arranged in sets to help develop particular skills. For example, to help develop pattern recognition, a set of cards can contain several pairs of cards that have similar pictures for children to match. Also, cards can be arranged in chronological or sequential formats to help develop a child's time awareness and sequencing skills.

While mental development of children is important, developing a child's physical abilities is equally as important to ensure a child's future well-being. There presently exist a substantial amount of games and activities that help young children learn a wide variety of physical movements. In a school setting for example, pre-grade school children often engage in exercise activities such as locomotor activities to learn movements like running, skipping and jumping, as well as movement to music and mirroring activities to learn movements like animals.

Due to the increasing amount of activities to be performed in a school day, teachers must often try to find ways to combine activities to ensure children are receiving the skills necessary to ensure proper child development. Making the task more difficult is finding an activity that combines skill sets, specifically those that develop certain mental and physical abilities, while also presenting an enjoyable interactive activity for children.

There has not been a substantial amount of prior art dealing with educational games or activities aimed at developing both the mental abilities, such as shape and color recognition, and physical abilities of young children with little or no reading ability. For example, U.S. Pat. No. 6,056,549 (Fletcher) discloses a communication and teaching aid for increasing the communication skills of a non-verbal, speech, and/or language impaired individual using a book containing removable pieces having pictures and corresponding words combined thereon. While this system may be helpful to greatly increase an individual's effective vocabulary or communication ability, it does not seek to help develop a child's physical movement capabilities. Further, children who do not possess the capability to read will not be able to fully utilize the invention to help improve communication skills and abilities.

U.S. Pat. No. 3,722,885 (Leaf) discloses an exercise game to help maintain physical fitness by improving cardiovascular endurance, flexibility, agility, balance, and strength through the performance of certain exercises. The game includes a board on which five piles of cards are stacked, the cards being each colored on one side to designate an exercise in a component area. Instructions for performance of a particular exercise are imprinted on the uncolored face of each card, with cards of the same color arranged into piles. A player rolls a colored die to determine which pile of cards to choose from, a card is then chosen from the correct colored pile, and the activity printed on the card is performed for a time period determined by the rolling of a numbered die. While the game seeks to help develop physical agility, it does not focus on helping young children without the ability to read or remember instructions develop mental association abilities.

U.S. Pat. No. 6,669,486 (Frankenberry et al.) discloses an educational system for educating learners by having them perform self-directed activities. The preferred system includes a set of distinct pictorial symbols and a training program that trains the learners to associate each of the pictorial symbols with a specific instruction. Once a learner is trained to associate a symbol with an instruction, the symbol is then used to instruct the learner to perform an educational activity. While this patent attempts to create a system that provides an opportunity for a learner to participate in an educational activity without having to read instructions, it does not offer an activity that can be performed by a group of children in a school setting. Further, this activity is limited in the type of skill sets that young children can learn.

Therefore, there exists a need for an educational game and activity that can introduce a variety of different movement and fitness skills to pre-grade school children or children with limited reading or learning skills, while simultaneously helping to develop color, number, and shape recognition capabilities.

With respect to the above, before explaining at least one preferred embodiment of the invention in detail, it is to be understood that the invention is not limited in its application to the details of construction and to the arrangement of the components or steps set forth in the following description or illustrated in the drawings. The various apparatus and methods of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other devices, methods and systems for carrying out the several purposes of the present disclosed device. It is important, therefore, that the objects and claims be regarded as including such equivalent construction and methodology insofar as they do not depart from the spirit and scope of the present invention.

### SUMMARY OF THE INVENTION

It is a principal advantage of the present invention to provide an educational game and activity that can introduce a variety of different movement skills to young children.

It is another advantage of the present invention to provide an educational game and activity that can help young children to develop color, number, and shape recognition skills.

It is still another advantage of the present invention to provide an educational game and activity that is inexpensive to purchase and maintain.

It is a further advantage of the present invention to provide an educational game and activity that is relatively easy to learn and engage in by young children.

It is still yet another advantage of the present invention to provide a new and unique game and activity to the field of educational material for children.

The present invention provides an educational game and activity that helps children develop fitness skills and color, number, and shape recognition abilities. The game includes a set of activity cards containing a front surface and a back surface. The front surface has an activity pictorial representation, in the most preferred mode of the method and device, three different levels of the activity repetition number that is located in the shape of a heart, octagon and pentagon, and an activity title located thereon. The three levels are, the numeral for the number, the word for the number of repetitions, and dots equal to the number of repetitions in case the child cannot read. The back surface has a shape title, a shape pictorial representation, and a color title located thereon. The game also preferably includes a die used to randomly select at least one activity card from the set of activity cards. The die can contain either color designations corresponding to the color titles on the activity cards, or shape designations corresponding to shape titles and shape pictorial representations on the activity cards. The die is used to select an activity card, the activity thereon is then performed for the amount of repetitions in the shape the instructor explains to use prior to play.

To engage in the above-described educational game and activity, a group of children is gathered in one area and the activity cards are mixed up on the floor in another location. An instructor then chooses the type of activity card selection means to be used, preferably either a shape or color recognition die that a child can roll. A child then rolls the die and chooses a card from the pile of cards corresponding to the shape or color that was rolled. The card is then brought back to the group, turned over, and the group performs the activity pictorially represented on the card, for the number of repetitions in the shape of the heart, octagon or pentagon that the instructor instructed the children to do prior to play. The instructor can vary the amount of repetitions by having the children perform the activity to music that is turned on or off. This process is repeated until the cards have all been used.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The accompanying drawings which are incorporated in and form a part of this specification illustrate embodiments of the disclosed processing system and together with the description, serve to explain the principles of the invention.

FIG. 1 depicts a front view of a representative sample of activity cards, constructed in accordance with the present invention, and FIG. 1a is a close up view of a typical card front view showing the three shapes with three levels of repetitions and three types of indica to indicate the number of repetitions.

FIG. 2 depicts a back view of a representative sample of activity cards, constructed in accordance with the present invention;

FIG. 3A depicts a perspective view of a color recognition die, constructed in accordance with the present invention;

FIG. 3B depicts a front view of each surface of a color recognition die, constructed in accordance with the present invention;

FIG. 4A depicts a perspective view of a shape recognition die, constructed in accordance with the present invention; and

FIG. 4B depicts a front view of each surface of a shape recognition die, constructed in accordance with the present invention.

### DETAILED DESCRIPTION OF THE PREFERRED EMBODIMENTS

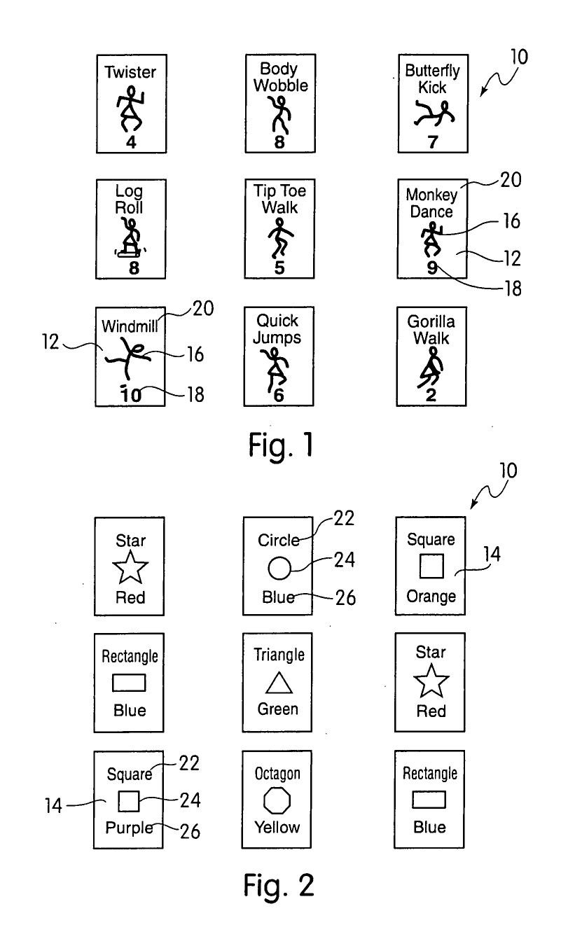

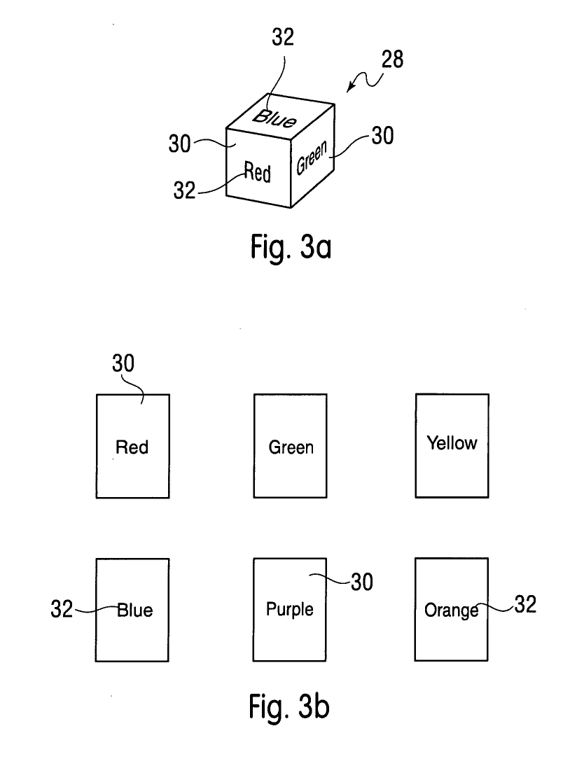

Referring now to the drawings of FIGS. 1-4, wherein similar parts are identified by like reference numerals, there is seen in FIG. 1 and FIG. 1a, a front view of a representative sample of activity cards 10. In the preferred embodiment, there are thirty-six activity cards 10 in each game set. Activity cards 10 contain a front surface 12 and a back surface 14 (see FIG. 2). Front surface 12 contains an activity pictorial representation 16, at least one but preferably three different levels of repetition which are shown in indica, in words 17 for the number 18 of repetitions above a heart, octagon and pentagon, and also with the numeral 19 for the number 18 of repetitions, and with dots 21 equal in number to the number 18 of the repetition amount in case the child cannot read. All three renditions representing that repetition amount 18 for either of the three levels of repetitions that can be chosen for performance. Also, an activity title 20 is located thereon. Front surface 12 can contain a color scheme to help identify particular activity cards 10 or to provide a designation for selection purposes by the children. For instance, if a colored die is used (see FIG. 3A), and a child rolls the die and a surface with the color red lands face up, a child can then pick an activity card 10 from a group of activity cards 10 that contain a front surface 12 colored in red. By placing three levels of repetitions, the instructor can direct the users to perform the level that is most appropriate for their level of exercise. By placing three types of indica to indicate how many repetitions to perform, the cards are appropriate for all age groups of children whether they can read, understand numerals, or count dots.

Activity pictorial representations 16 allow children with little reading ability to immediately comprehend the general motion of the activity to be performed. Preferably, only one activity pictorial representation 16, is on each card. As noted, on the card are three sets of indica for the number of activity repetitions, the numeral, the word, and dots, equal to the numbers 18, of repetitions to be performed. Also, one activity title 20 are located on front surface 12. However, it is within the scope of the present invention to have other embodiments that include more than one activity pictorial representation 16, activity repetition number 18, or activity title 20 located on front surface 12.

Activity repetition number 18 indicates the amount of repetitions that are to be performed of the named activity. The activity repetition number 18 can vary from a range of 1-10. However, it is possible that an individual instructor can vary the amount of repetitions performed by having children perform the activity to a rhythm or by turning music on or off.

Activity title 20 describes the name of the activity to be performed. Activity title 20, in conjunction with activity pictorial representation 16, helps children to associate words with a particular set of movements within an activity. Activity titles 20 generally consist of activities that can be rather easily and safely performed by young children. Representative activity titles 20 include, but are not limited to: Chimpanzee Dance, Tornado, Jumping Jacks, Tip Toe Walk, Reach for the Stars, Butterfly Kick, Windmill, Turtle Crawl, Grass Hopper, Hand Shuffle, Helicopter, Skate Slide, Can-Can Crab, Log Roll, Leg Crosser, Skipper, Jog in Place, Galloping Pony, Gorilla Walk, Slide Stepping, Body Balance, Twister, Imaginary Jump Rope, Pogo Bounce, Leg Shuffle, Monkey Dance, Flamingo Stance, Piano Keys, Quick Jumps, Frankenstein Walk, Scissor Jump, and Body Wobble.

As illustrated in FIG. 2, there is depicted a back view of a representative sample of activity cards 10. Back surface 14 contains a shape title 22, a shape pictorial representation 24, and a color title 26. Preferably, one shape title 22, one shape pictorial representation 24, and one color title 26 are located on back surface 14. However it is within the scope of the present invention to have other embodiments that include more than one shape title 22, shape pictorial representation 24, or color title 26 located on back surface 14.

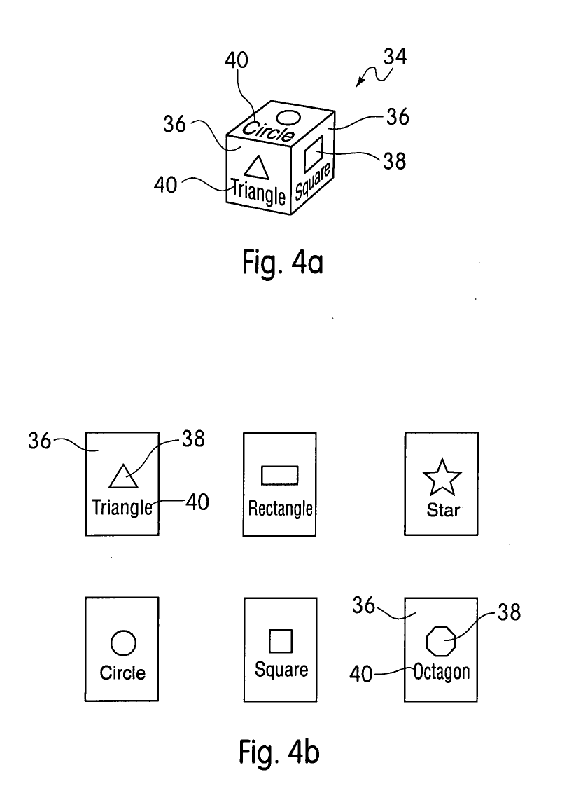

Shape title 22 refers to the name of the shape that is depicted on activity card 10. Preferably, shape title 22 is located on the bottom portion of back surface 14. However, it is within the scope of the present invention for shape title 22 to appear anywhere on back surface 14. Shape title 22 can be used to help identify particular activity cards 10 or to provide a designation for selection purposes by the children. For instance, if a shape die is used (see FIG. 4A), and a child rolls the shape entitled square, a child can then pick an activity card 10 from a group of activity cards 10 that contain a shape title 22 of square. Shape title 22 generally includes the names of shapes that can quickly and readily be recognized by young children. Shape title 22 can include, but is not limited to the shapes of star, circle, square, rectangle, triangle, and diamond.

Shape pictorial representation 24 is the symbol that preferably appears in a central location on back surface 14. However, it is within the scope of the present invention for pictorial representation 24 to appear anywhere on back surface 14. Shape pictorial representation 24 can be used to help identify particular activity cards 10 or to provide a designation for selection purposes by the children. For instance, if a shape die is used (see FIG. 4A), and a child rolls the shape entitled square, a child can then pick an activity card 10 from a group of activity cards 10 that contain a shape pictorial representation 24 of square. Shape pictorial representation 24 generally includes the names of shapes that can quickly and readily be recognized by young children. Shape pictorial representation 24 can include, but is not limited to the shapes of star, circle, square, rectangle, triangle, and diamond.

Color title 26 refers to the name of the color scheme represented on back surface 14 on activity card 10. Preferably, color title 26 is located on the bottom portion of back surface 14. However, it is within the scope of the present invention for color title 26 to appear anywhere on back surface 14. Color title 26 can be used to help identify particular activity cards 10 or to provide a designation for selection purposes by the children. For instance, if a color die is used (see FIG. 3A), and a child rolls the color red, a child can then pick an activity card 10 from a group of activity cards 10 that contain a color title 26 of red. Color title 26 generally includes the names of colors that can quickly and readily be recognized by young children. Color title 26 can include, but is not limited to the colors red, green, blue, yellow, orange, and purple.

As illustrated in FIG. 3A, there is depicted a perspective view of a color recognition die 28 that can be used in conjunction with activity cards 10. Color recognition die 28 preferably consists of a standard small and lightweight die containing six die surfaces 30. However, color recognition die 28 can contain more or less die surfaces 30, ranging from four upward to any number of die surfaces 30 provided each of die surfaces 30 is large enough to contain legible writing and shape recognition die 34 does not become too heavy and cumbersome to be handled and rolled by young children. Each of die surfaces 30 can contain a different color, as well as include a color designation 32 matching the specific surface color. Color designation 32 refers to the color identifying word displayed on the die surface 30. For example, a die surface 30 that is blue in color will have the word “blue” displayed as its color designation 32. Color designations 32 generally include the names of colors that can readily be recognized by young children. Color designations 32 can include, but are not limited to the colors red, green, blue, yellow, orange, and purple.

As illustrated in FIG. 3B, there is depicted a front view of each die surface 30 of the preferred embodiment of color recognition die 28. Shown in the figure are die surfaces 30 containing color designations 32 of red, green, yellow, blue, purple, and orange.

As illustrated in FIG. 4A, there is depicted a perspective view of a shape recognition die 34 that can be used in conjunction with activity cards 10. Shape recognition die 34 preferably consists of a standard small and lightweight die containing six die surfaces 36. However, shape recognition die 34 can contain more or less die surfaces 36, ranging from four upward to any number of die surfaces 36 provided each of die surfaces 36 is large enough to contain legible writing and shape recognition die 34 does not become too heavy and cumbersome to be handled and rolled by young children. Each of die surfaces 36 can contain a different shape 38, as well as include a shape designation 40 matching the specific shape 38.

Shape designation 40 refers to the word identifying shape 38 displayed on die surface 36. For example, a die surface 36 that contains the shape 38 “square” will have the word “square” displayed as its shape designation 40. Shape designation 40 generally includes the names of shapes 38 that can quickly and readily be recognized by young children. Shape designation 40 can include, but is not limited to the shapes 38 of square, rectangle, triangle, diamond, star, and circle.

Preferably, each of die surfaces 36 is blue in color, with shapes 38 and shape designations 40 being displayed in a white color. However, the present invention also embodies a shape recognition die 34 that can contain any color combination wherein each of die surfaces 36 are comprised of similar colors and each of shapes 38 and shape designations 40 are comprised of similar colors.

As illustrated in FIG. 4B, there is depicted a front view of each die surface 36 of the preferred embodiment of shape recognition die 34. Shown in the figure are die surfaces 36 containing shapes 38 and shape designations 40 of triangle, rectangle, star, circle, square, and diamond.

Although shape recognition die 28 and color recognition die 34 are the preferred means for randomly selecting at least one activity card 10 from the set of activity cards 10, the present invention can also include other means for randomly selecting activity cards 10 based on shapes or colors. For example, a spinning wheel and pointer can be used, wherein the wheel contains various shapes and colors depicted on its surface. In this scenario, a child spins the wheel, and when the wheel stops spinning the pointer will point to a shape or color of the activity card 10 to be selected by the child. Additionally, other means such as an instructor can hold up an object, like an apple (shape recognition-circle, or color recognition-red). In this scenario, a child will then select the shape or color of that activity card matching that object can be used.

The device herein shown in the drawings and described in detail herein disclose arrangements of elements of particular construction, and configuration for illustrating preferred embodiments of structure of the present invention. It is to be understood, however, that elements of different construction and configuration, and different steps and process procedures, and other arrangements thereof, other than those illustrated and described, may be employed for providing an educational game and activity formed thereof in accordance with the spirit of this invention.

As such, while the present invention has been described herein with reference to particular embodiments thereof, a latitude of modifications, various changes and substitutions are intended in the foregoing disclosure, and will be appreciated that in some instance some features of the invention could be employed without a corresponding use of other features, without departing from the scope of the invention as set forth in the following claims. All such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting, as to the scope of the invention in any way.

I claim:

1. An educational game and activity for a group of young children comprising:
a) a set of activity cards, each of said set of activity cards having a front surface and a having a back surface, said front surface having a pictorial representation of an activity to perform, three different numbers indicating a repetition number of said activity respectively inside the shape of a heart, octagon and pentagon, and having groups of dots matching said number adjacent to or inside each respective said heart, said octagon, and said pentagon, and having a word matching each said number adjacent to or inside each respective said heart, said octagon, and said pentagon, and having an activity title located on said front surface, each said card having a back surface having a shape title of a shape pictorial representation thereon, and a color title located thereon; and
b) means for randomly selecting at least one activity card from said set of activity cards; and
whereby, to engage in the game and activity, a group of children is divided into sub groups away from said set of activity cards, a member of each sub group then employs said means for randomly selecting at least one activity card from said set of activity cards to select an activity card, the member then goes to said set of activity cards and selects the appropriate activity card and brings the activity card back to the sub group wherein each member of the sub group performs the activity for the number of repetitions according to one of said three numbers indicating a said repetition number, the game repeating the process until all of said activity cards have been used.

2. The educational game and activity of claim 1, wherein said activity repetition number ranges from about 1 to 10.

3. The educational game and activity of claim 1, wherein said front surface further includes a color scheme for the purpose of helping to identify particular activity cards.

4. The educational game and activity of claim 1, wherein said shape title is selected from the group of shapes consisting of square, rectangle, triangle, diamond, circle, and star.

5. The educational game and activity of claim 1, wherein said shape pictorial representation is selected from the group of shapes consisting of square, rectangle, triangle, octagon, circle, and star.

6. The educational game and activity of claim 1, wherein said color title is selected from the group of colors consisting of red, blue, green, orange, purple, and yellow.

7. The educational game and activity of claim 1, wherein said means for randomly selecting at least one activity card from said set of activity cards is a die containing a plurality of surfaces located thereon.

8. The educational game and activity of claim 7, wherein each of said plurality of surfaces contains an activity card group identification symbol located thereon for the purpose of identifying an activity card group from which an activity card can be chosen therefrom.

9. The educational game and activity of claim 8, wherein said activity card group identification symbol is a name of a color.

10. The educational game and activity of claim 9, wherein said name of a color is selected from the group of colors consisting of red, blue, green, orange, purple, and yellow.

11. The educational game and activity of claim 8, wherein said activity card group identification symbol is a shape.

12. The educational game and activity of claim 11, wherein said shape is selected from the group of shapes consisting of square, rectangle, triangle, diamond, circle, and star.

13. The educational game and activity of claim 7, wherein said plurality of surfaces is six.

14. An educational game and activity for a group of young children comprising:
a) a set of activity cards, each of said set of activity cards containing a front surface and a back surface, said front surface having an activity pictorial representation, three numbers indicating a repetition number of said activity with one each respectively inside the shape of a heart, octagon or pentagon, with dots matching that amount inside or adjacent to said heart, octagon, and pentagon, an activity title, and a color scheme located thereon, said back surface having a shape title, a shape pictorial representation, and a color title located thereon, said shape pictorial representation being selected from the group of shapes consisting of square, rectangle, triangle, diamond, circle, and star;
b) means for randomly selecting at least one activity card from said set of activity cards; and
whereby, to engage in the game and activity, a group of children is divided into sub groups away from said set of activity cards, a member of each sub group then uses said means for randomly selecting at least one activity card from said set of activity cards to select an activity card, the member then goes to said set of activity cards and selects the appropriate activity card and brings the activity card back to the sub group wherein each member of the sub group performs the activity for the number of repetitions according to said activity repetition number, the game repeating the process until all of said activity cards have been used.

15. The educational game and activity of claim 14, wherein said color title is selected from the group of colors consisting of red, blue, green, orange, purple, and yellow.

16. The educational game and activity of claim 14, wherein said means for randomly selecting at least one activity card from said set of activity cards is a die containing a plurality of surfaces located thereon.

17. The educational game and activity of claim 14, wherein each of said plurality of surfaces contains an activity card group identification symbol located thereon for the purpose of identifying an activity card group from which an activity card can be chosen therefrom.

18. The educational game and activity of claim 17, wherein said activity card group identification symbol is a shape.

19. A method for making an educational game and activity for a group of young children comprising the steps of:
a) providing a set of activity cards, each of said set of activity cards containing a front surface and a back surface;
b) imprinting said front surface with an activity pictorial representation, an activity repetition number, and an activity title;
c) imprinting said back surface with a shape title, a shape pictorial representation, and a color title;
d) providing means for randomly selecting at least one activity card from said set of activity cards;
e) displaying color identifying symbols corresponding to said color title on said means for randomly selecting at least one activity card from said set of activity cards;
f) allowing players to employ said means for randomly selecting said one activity card to select a chosen card from said set;
g) having said players perform said activity identified in said activity pictorial for said repetition number;
h) having said players employ said means for randomly selecting said one activity card to select subsequent said chosen cards from said set and perform subsequent said activities identified in said pictorial; and
i) having said players repeat step h until all said activity cards in said set have been chosen.

20. The method for making an educational game and activity for a group of young children of claim 19, wherein said step of displaying color identifying symbols corresponding to said color title on said means for randomly selecting at least one activity card from said set of activity cards is replaced with the step of displaying shape identifying symbols corresponding to said shape title and shape pictorial representation on said means for randomly selecting at least one activity card from said set of activity cards.
